(19) United States
(12) Patent Application Publication
(10) Pub. No.: US 2026/0282053 A1
(43) Pub. Date: Sep. 17, 2026

(54) CONTROL OF UE MBS REPORTING FOR SHARED PROCESSING

(71) Applicant: APPLE INC., Cupertino, CA (US)

(72) Inventors: Fangli XU, Beijing (CN); Peng CHENG, Beijing (CN); Alexander SIROTKIN, Hod Hasharon (IL); Ping-Heng KUO, London (GB); Yuqin CHEN, Beijing (CN); Zhibin WU, Los Altos, CA (US); Naveen Kumar R PALLE VENKATA, San Diego, CA (US); Ralf ROSSBACH, Munich (DE); Haijing HU, Los Gatos, CA (US)

(73) Assignee: APPLE INC., Cupertino, CA (US)

(21) Appl. No.: 19/471,510

(22) PCT Filed: Apr. 6, 2023
(86) PCT No.: PCT/CN2023/086544

§ 371 Date: Oct. 1, 2025

(51) Int. Cl. H04W 72/30

(52) U.S. Cl. CPC H04W 72/30

(57) ABSTRACT

Disclosed herein are system, method, and computer program product embodiments for control of user equipment (UE) multicast and broadcast services (MBS) reporting for shared processing. An embodiment operates by receiving a message, from a serving base station (BS), broadcast service (MBS) reporting. Based on a determination that the UE does not have sufficient UE resources to simultaneously receive an MBS transmission from an MBS BS and a first unicast transmission from the serving BS, the embodiment transmits an MBS report to the serving BS. Finally, the embodiment receives a second unicast transmission from the serving BS, wherein a signal resource configuration of the second unicast transmission is determined based on the MBS report.

### BACKGROUND

### Field

The described aspects generally relate to mechanisms for multicast and broadcast services (MBS) in a wireless communication system.

### Related Art

5G New Radio (NR) supports multicast broadcast services (MBS) that enable efficient content delivery to multiple users simultaneously. MBS is particularly useful in scenarios where the same content needs to be delivered to a large group of users, such as public safety and mission-critical operations, vehicle-to-everything (V2X) applications, live events, video streaming, and software delivery over wireless among others.

### SUMMARY

Some aspects of this disclosure relate to apparatuses and methods for control of MBS reporting for shared processing. For example, some aspects of this disclosure relate to configuring a user equipment (UE) to transmit an MBS report to a serving base station (BS), and the serving BS adjusts the configuration of signal resources for subsequent unicast transmissions such that the UE will be able to receive and process both broadcast and unicast transmissions simultaneously

Some aspects of this disclosure relate to a UE that has a transceiver configured to enable wireless communication and a processor communicatively coupled to the transceiver. The processor is configured to receive a message from a serving BS, indicating support for MBS reporting. Based on a determination that the UE does not have sufficient UE resources to simultaneously receive an MBS transmission from an MBS BS and a first unicast transmission from the serving BS, the UE transmits, using the transceiver, an MBS report to the serving BS. The UE then receives a second unicast transmission from the serving BS, wherein a signal resource configuration of the second unicast transmission is determined based on the MBS report.

According to some aspects, the message indicating support for MBS reporting is received within a system information block 1 (SIB1) message, and the processor is further configured to transmit an initial-MBS-report comprising essential-type MBS configuration information regarding a frequency corresponding to the MBS transmission. The UE then receives, from the serving BS, a radio resource control (RRC) message indicating a request to transmit full-set type MBS configuration information regarding the frequency corresponding to the MBS transmission. The UE then includes, within the MBS report, full-set type MBS configuration information regarding the frequency corresponding to the MBS transmission. According to some aspects, the SIBI message includes an indication of a type of the MBS configuration information that is to be included in the initial-MBS-report, where the type of the MBS configuration information is either an essential-type or a full-set type.

According to some aspects, the message indicating support for MBS reporting includes a list of public land mobile networks (PLMNs) for which the serving BS has MBS configuration information, and based on a determination that the MBS BS is operating on a PLMN that is included in the list of PLMNs, the processor is further configured to include, within the MBS report, essential-set type MBS configuration information corresponding to the PLMN. According to some aspects, based on a determination that the MBS BS is operating on a PLMN that is not included in the list of PLMNs, the processor is further configured to include, within the MBS report, full-set type MBS configuration information corresponding to the PLMN.

According to some aspects, the message indicating support for MBS reporting includes a list of frequencies for which the serving BS has MBS configuration information, and based on a determination that a frequency corresponding to the MBS transmission is included in the list of frequencies, the processor is further configured to include, within the MBS report, essential-set type MBS configuration information corresponding to the frequency. According to some aspects, based on a determination that the frequency corresponding to the MBS transmission is not included in the list of frequencies, the processor is further configured to include, within the MBS report, full-set type MBS configuration information corresponding to the frequency.

According to some aspects, the message indicating support for MBS reporting is received within a SIB1 message. Alternatively, the message indicating support for MBS reporting is received within an RRC message. According to some aspects, the MBS report includes essential-set type MBS configuration information regarding a frequency corresponding to the MBS transmission, and wherein the essential-type MBS information comprises one or more of the following: an MBS service identifier and an identifier corresponding to the frequency. Alternatively, the MBS report includes full-set type MBS configuration information regarding a frequency corresponding to the MBS transmission, and wherein the full-set type MBS information comprises one or more of the following: MBS bandwidth, MBS bandwidth location, subcarrier spacing, modulation order, and discontinuous reception (DRX) configuration.

Some aspects of this disclosure relate to a BS that has a transceiver configured to enable wireless communication and a processor communicatively coupled to the transceiver. The processor is configured to transmit a message indicating support for multicast and broadcast service (MBS) reporting. The BS then transmits, using the transceiver, a first unicast transmission to a UE, The BS then receives, from the UE, an MBS report indicating that the UE does not have sufficient UE resources to simultaneously receive an MBS transmission from an MBS BS and the first unicast transmission. The BS then transmits, using the transceiver, a second unicast transmission, wherein a signal resource configuration of the second unicast transmission is determined based on the received MBS report. According to some aspects, the message indicating support for MBS reporting is transmitted within a SIB1 message. Alternatively, the message indicating support for MBS reporting is transmitted within an RRC message, according to some aspects.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example wireless system implementing control of UE MBS reporting for shared processing, according to some aspects of this disclosure.

FIG. 2 illustrates a block diagram of an example system of an electronic device implementing control of UE MBS reporting for shared processing, according to some aspects of this disclosure.

FIGS. 3A-3B illustrate exemplary decoupled processing and shared processing of unicast and broadcast transmissions at a UE, according to some aspects of this disclosure.

FIGS. 4A-4C illustrate example structures of an MBS report sent by a UE, according to some aspects of this disclosure.

FIG. 5 illustrates an exemplary two-step MBS reporting procedure, according to some aspects of this disclosure.

FIGS. 6A-6B illustrate exemplary one-step MBS reporting procedures with broadcast control, according to some aspects of this disclosure.

FIG. 7 illustrates an exemplary one-step MBS reporting procedure with dedicated-signaling control, according to some aspects of this disclosure.

FIG. 8 illustrates an exemplary MBS reporting procedure in which the UE always sends a full-set type report to the serving BS, according to some aspects of this disclosure.

FIG. 9 illustrates an exemplary method performed by a UE implementing MBS reporting for shared processing, according to some aspects of this disclosure.

FIG. 10 illustrates an exemplary method performed by a UE implementing MBS reporting for shared processing, according to some aspects of this disclosure.

FIG. 11 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Use case scenarios for 5G new radio (NR) include enhanced mobile broadband (eMBB), ultra-reliable low-latency communications (URLLC), and massive machine type communications (mMTC). These use cases cover a wide range of applications with highly diverse requirements. For example, eMBB is designed to cater to the large capacities needed to accommodate high user density scenarios, mMTC services are characterized by a massive number of sensors or connected devices which typically transmit low volume of non-delay sensitive data, and URLLC services refer to services that are expected to have exceptionally low latency and extremely high reliability.

In addition, NR functional support for multicast and broadcast services (MBS) was introduced as part of 3GPP release 17 (Rel-17). MBS is a point-to-multipoint service that can improve the network efficiency and user experience when transmitting the same content to multiple users. MBS is targeted to enable diverse services, including public safety and mission-critical, vehicle-to-everything (V2X) applications, Internet Protocol television (IPTV), live video, software delivery over wireless, and Internet of things (IOT) applications, etc. Two delivery modes for MBS were defined in Rel-17: delivery mode 1 for multicast and delivery mode 2 for broadcast. Delivery mode 1 addresses higher QoS services and applies to UEs in radio resource control (RRC) connected state that has joined an MBS session. Delivery mode 2 addresses lower QoS services and applies to all MBS UEs in a service area regardless of the RRC state.

5G-Advanced is expected to support further enhancements to MBS, such as joint reception of unicast transmissions and broadcast transmissions from the same or different network operations. Enhanced signaling schemes to support the simultaneous reception of unicast transmissions and broadcast transmissions are needed to enable enhanced next-generation MBS deployments.

To address the above technological issues, embodiments herein provide control of MBS reporting for UEs performing shared processing. Some aspects of this discourse relate to signaling enhancements to enable a UE, implementing shared processing, to simultaneously receive and process unicast transmissions (in RRC connected state) and MBS broadcast transmissions from the same or different network operations.

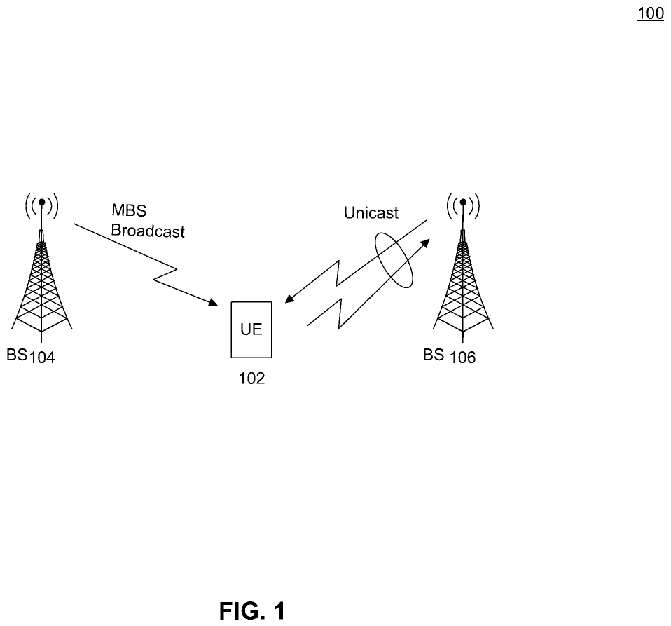

FIG. 1 illustrates an exemplary wireless system 100 implementing control of UE MBS reporting for shared processing, according to some aspects of the disclosure. The example wireless system 100 is provided for the purpose of illustration only and does not limit the disclosed aspects. Wireless system 100 may include, but is not limited to, user equipment 102 and base stations 104 and 106.

According to some aspects, base station (BS) 104 and BS 106 can be a fixed station or a mobile station. BS 104 and BS 106 may be referred to as a cellular IoT base station, an evolved NodeB (eNB), a next-generation eNB (ng-eNB), a 5G node B (NB), or some other equivalent terminology. In some examples, BS 104 and BS 106 can be interconnected to one another and/or to other base stations or network nodes in a network through various types of backhaul interfaces such as a direct physical connection, a virtual network, and/or the like, not shown.

According to some aspects, UE 102 can be configured to operate based on a wide variety of wireless communication techniques. These techniques can include, but are not limited to, techniques based on 3rd Generation Partnership Project (3GPP) standards. UE 102 can be a stationary or a mobile device. UE 102 can be a cellular phone (e.g., a smart phone), a personal digital assistant (PDA), a wireless modem, a wireless communication device, a handheld device, a laptop, a desktop, a cordless phone, a wireless local loop station, a wireless sensor, a tablet, a camera, a video surveillance camera, a gaming device, a netbook, an ultrabook, a medical device or equipment, a biometric sensor or device, a wearable device (smart watch, smart clothing, smart glasses, smart wrist band, smart jewelry such as smart ring or smart bracelet), an entertainment device (e.g., a music or video device, or a satellite radio), a vehicular component, a smart meter, an industrial manufacturing equipment, a global positioning system device, an Internet-of-Things (IOT) device, a machine-type communication (MTC) device, an evolved or enhanced machine-type communication (eMTC) device, or any other suitable device that is configured to communicate via a wireless medium. For example, a MTC and eMTC device can include a robot, a drone, a location tag, and/or the like. Furthermore, UE 102 can be an augmented reality device, a virtual reality device, a mixed reality device, or the like.

According to some aspects, UE 102 can be in range to communicate with BS 106 as well as with BS 104. UE 102 can have an RRC connection established with BS 106, such that BS 106 acts as a serving BS and UE 102 can be configured to receive unicast (i.e., non-MBS) transmissions from serving BS 106. BSs 104 can configure one or more radio bearers to transmit MBS data to UE 102. According to some aspects, BS 104 can transmit MBS data to UE 102 over a multicast radio bearer (MRB) that may be shared by multiple other UEs. According to some aspects, BS 104 can transmit MBS data to UE 102 over a dedicated DRB. UE 102 may be configured to receive MBS transmissions from BSs 106 and 104. Furthermore, BSs 104 and 106 can transmit unicast data to UE 102 over a dedicated data radio bearer (DRB).

According to some aspects, UE 102 performs a shared processing of broadcast MBS transmission received from BS 104 (henceforth referred to as MBS BS 104) and the unicast transmission received from BS 106 (henceforth referred to as serving BS 106). Upon simultaneously receiving the broadcast MBS transmission from the MBS BS 104 and the unicast transmission from the serving BS 106, UE 102 can determine whether it has sufficient hardware and/or RF resources to simultaneously process the broadcast MBS transmission 108 and the unicast transmission 110. If UE 102 determines that it does not have sufficient UE resources to receive and process the unicast transmission 110 along with the MBS broadcast transmission 108, it configures an MBS report to send to the serving BS 106. According to some aspects, after receiving the MBS report, based on UE capability, serving BS 106 can adjust the configuration of signal resources for subsequent unicast transmissions such that UE 102 will be able to receive and process the broadcast MBS transmission 108 and upcoming unicast transmissions simultaneously.

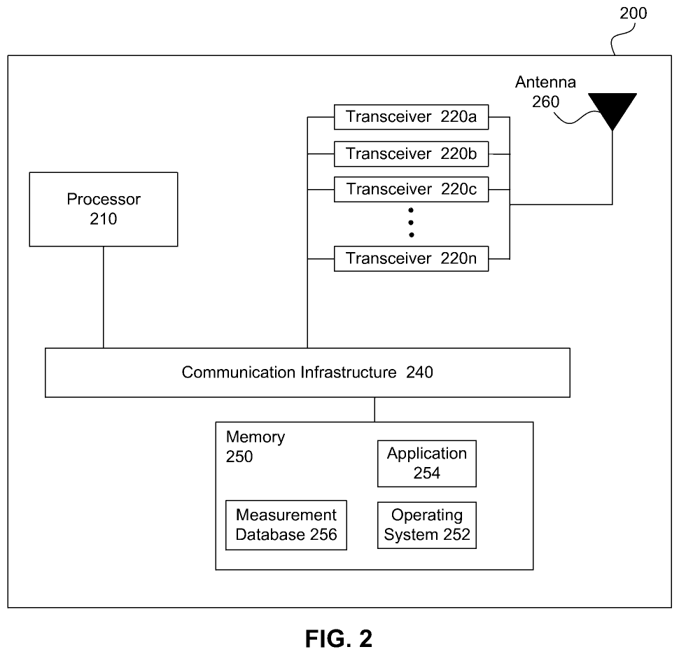

FIG. 2 illustrates a block diagram of an example system 200 of an electronic device implementing control of UE MBS reporting for shared processing, according to some aspects of the disclosure. System 200 may be any of the base stations 101 or 107, and/or UE 103 of system 100. System 200 includes processor 210, one or more transceivers 220a-220n, communication infrastructure 240, memory 250, operating system 252, application 254, and antenna 260. Illustrated systems are provided as exemplary parts of system 200, and system 200 can include other circuit(s) and subsystem(s). Also, although the systems of system 200 are illustrated as separate components, the aspects of this disclosure can include any combination of these, less, or more components.

Memory 250 may include random access memory (RAM) and/or cache, and may include control logic (e.g., computer software) and/or data. Memory 250 may include other storage devices or memory such as, but not limited to, a hard disk drive and/or a removable storage device/unit. According to some examples, operating system 252 can be stored in memory 250. Operating system 252 can manage transfer of data from memory 250 and/or one or more applications 254 to processor 210 and/or one or more transceivers 220a-220n. In some examples, operating system 252 maintains one or more network protocol stacks (e.g., Internet protocol stack, cellular protocol stack, and the like) that can include a number of logical layers. At corresponding layers of the protocol stack, operating system 252 includes control mechanism and data structures to perform the functions associated with that layer.

According to some examples, application 254 can be stored in memory 250. Application 254 can include applications (e.g., user applications) used by wireless system 200 and/or a user of wireless system 200. The applications in application 254 can include applications such as, but not limited to, radio streaming, video streaming, remote control, and/or other user applications.

System 200 can also include communication infrastructure 240. Communication infrastructure 240 provides communication between, for example, processor 210, one or more transceivers 220a-220n, and memory 250. In some implementations, communication infrastructure 240 may be a bus. Processor 210 together with computer instructions stored in memory 250 performs operations enabling system 200 of system 100 to implement control of UE MBS reporting for shared processing, according to some aspects of the disclosure, as described herein. Alternatively, processor 210 can be “hard-coded” to implement control of UE MBS reporting for shared processing, as described herein.

One or more transceivers 220a-220n transmit and receive communications signals that support UE MBS reporting for shared processing, according to some aspects, and may be coupled to antenna 260. Antenna 260 may include one or more antennas that may be the same or different types. One or more transceivers 220a-220n allow system 200 to communicate with other devices that may be wired and/or wireless. In some examples, one or more transceivers 220a-220n can include processors, controllers, radios, sockets, plugs, amplifiers, filters, buffers, and like circuits/devices used for connecting to and communication on networks. According to some examples, one or more transceivers 220a-220n include one or more circuits to connect to and communicate on wired and/or wireless networks.

According to some aspects, one or more transceivers 220a-220n can include a cellular subsystem, a WLAN subsystem, and/or a Bluetooth TM subsystem, each including its own radio transceiver and protocol(s) as will be understood by those skilled arts based on the discussion provided herein. In some implementations, one or more transceivers 220a-220n can include more or fewer systems for communicating with other devices.

In some examples, one or more transceivers 220a-220n can include one or more circuits (including a WLAN transceiver) to enable connection(s) and communication over WLAN networks such as, but not limited to, networks based on standards described in IEEE 802.11. Additionally, or alternatively, one or more transceivers 220a-220n can include one or more circuits (including a Bluetooth IM transceiver) to enable connection(s) and communication based on, for example, Bluetooth protocol, the Bluetooth™ Low Energy protocol, or the Bluetooth Low Energy Long Range protocol. For example, transceiver 220n can include a Bluetooth transceiver.

Additionally, one or more transceivers 220a-220n can include one or more circuits (including a cellular transceiver) for connecting to and communicating on cellular networks such as 5G NR and the like. For example, one or more transceivers 220a-220n can be configured to operate according to one or more of Rel-15, Rel-16, Rel-17, or other of the 3GPP standards.

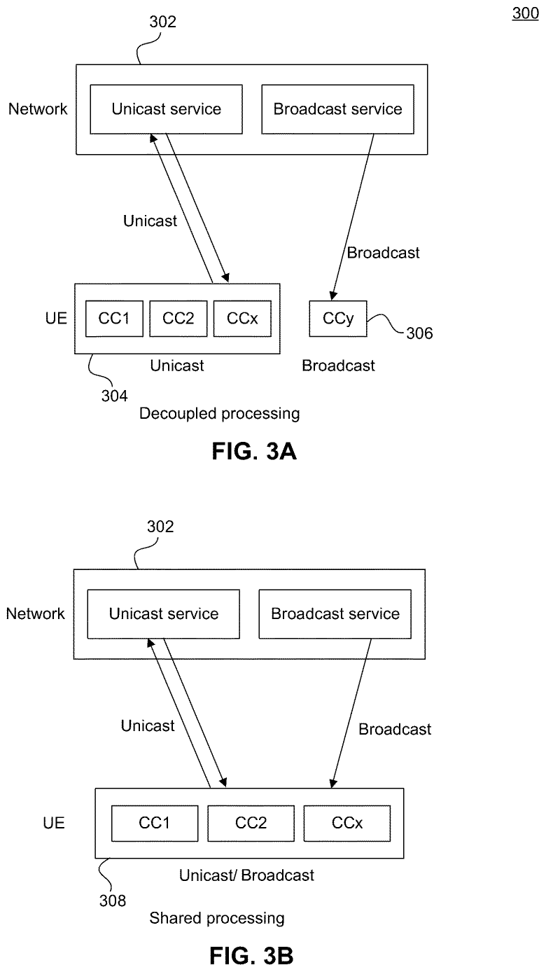

FIGS. 3A-3B illustrate exemplary decoupled processing and shared processing of unicast and broadcast transmissions at a UE, according to some aspects of this disclosure. FIG. 3A illustrates a decoupled processing of downlink unicast and broadcast transmissions. According to some aspects, a UE performing decoupled processing uses separate hardware resources and/or RF resources (e.g., RF front end circuits) to process the received unicast and broadcast transmissions. In the example of FIG. 3A, a UE may simultaneously receive an MBS broadcast transmission from MBS BS 104 and a unicast transmission from serving BS 106. According to some aspects, broadcast transmission may involve transmitting over a SIB, a multicast control channel (MCCH), and/or a multicast traffic channel (MTCH). The network 302 may configure the unicast transmission over a set of aggregated carrier components (CCs) 304 (e.g., CC1, CC2, and CCx), and the network may configure broadcast transmission over carrier component CCy 306. Furthermore, since UE 102 performs decoupled processing of the unicast and broadcast transmissions, the number of CCs and/or the bandwidths of the CCs allotted for the unicast transmission does not affect the UE's ability to receive a simultaneous MBS broadcast transmission over broadcast CCs (e.g., CCy).

FIG. 3B illustrates shared processing of downlink unicast and broadcast transmissions. According to some aspects, UE 102 performing shared processing uses common hardware components and/or RF resources (e.g., RF front end circuits) to process the downlink unicast and broadcast transmissions. The common hardware and RF resources can include processor and/or receiver component chains necessary for processing of the unicast and broadcast transmissions. Herein, the hardware resources and/or RF resources can also be referred to as “UE resources” for convenience of discussion. In the example of FIG. 3B, UE 102 may simultaneously receive an MBS broadcast transmission from MBS BS 104 and a unicast transmission from serving BS 106. According to some aspects, broadcast transmission may involve transmitting over a SIB, a MCCH, and/or a MTCH. The network 302 may configure both the unicast transmission as well as the broadcast transmission over a set of aggregated CCs 308 (e.g., CC1, CC2, and CCx). Since UE 102 performs shared processing of the unicast and broadcast transmissions, the number of CCs and/or the bandwidths of the CCs allotted for the unicast transmission can affect the UE's ability to receive a simultaneous broadcast transmission over the set of aggregated CCs. According to some aspects, due to limited processing capability and/or hardware resources, UE 102 may not be able to receive a simultaneous broadcast MBS transmission along with a unicast transmission that may consume a large amount of processing resources. Accordingly, based on UE capability (e.g., UE resources) a transmitting serving BS 106 may adjust resource configuration for the unicast transmission to enable shared processing of broadcast and unicast transmissions at UE 102.

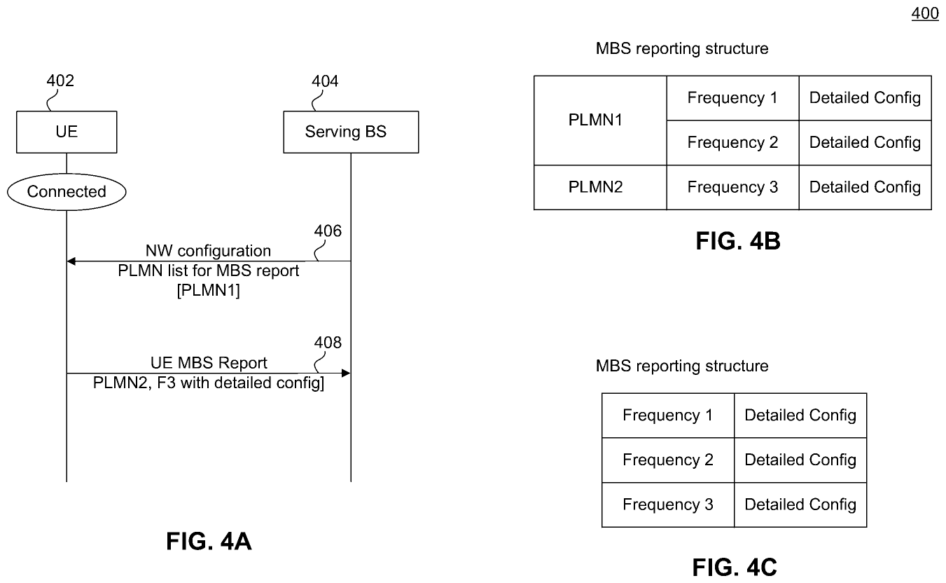

FIGS. 4A-4C illustrate example structures of an MBS report sent by a UE. FIG. 4A illustrates exchange of MBS information between serving BS 404 and UE 402. According to some aspects, in some cases, the network and the serving BS 404 may not have any information regarding MBS deployments in UE 104's neighbor cells (e.g., when the network operators for the unicast and the MBS deployment are not the same).

However, in other cases, the network may have MBS information corresponding to one or more neighbor cells of UE 402. For example, the network may obtain information regarding UE 402's neighbor cell MBS deployment from an operations and management server or an earlier MBS report from UE 402.

In the example of FIG. 4A, serving BS 404 sends a network configuration along with a list 406 of PLMNs and/or frequencies used for MBS. List 406 includes the PLMNs and/or frequencies for which the network has MBS configuration information. According to some aspects, list 406 can include a list of MBS services for which the network has MBS configuration information. Based on the list of PLMNs and/or frequencies received from the serving BS 404, UE 402 configures an MBS report 408 and sends it to the serving BS 404.

To configure the MBS report 408, UE 402 first determines the PLMN, the frequency, and/or the service corresponding to MBS BS from which UE 402 is receiving or is interested in receiving an MBS broadcast. Next, UE 402 determines whether the PLMN, frequency, and/or MBS service corresponding to the MBS transmission is included in the list 406 received from the serving BS 404. According to some aspects, if UE 402 determines that the PLMN and/or the frequency corresponding to the MBS transmission is not included in the list received from the serving BS 404, UE 402 configures an MBS report that includes a full-set type report regarding the PLMN and the frequency corresponding to the MBS transmission. In contrast, if UE 402 determines that the PLMN and/or the frequency corresponding to the MBS transmission is included in the list 406, UE 402 configures an MBS report that includes only an essential-set type report regarding the PLMN and the frequency.

In the example of FIG. 4A, serving BS 404 sends a list 406 indicating that it has MBS configuration information corresponding to PLMN1. In response to receiving list 406, UE responds with a MBS report that includes a full-set type MBS report corresponding to PLMN2 and frequency F3. This indicates that UE 402 is receiving MBS broadcast transmission, over a frequency band F3, from a MBS BS that belong to PLMN2.

FIGS. 4B and 4C illustrate example structures of MBS reports that UE 402 may generate. According to some aspects, MBS report 408 sent by UE 402 can include an essential-set type MBS report or a full-set type MBS report corresponding to one or more PLMNs, frequencies, and/or MBS services. FIG. 4B illustrates a PLMN-based MBS report. In the example of FIG. 4B, MBS report corresponding to PLMN1 includes information corresponding to frequencies 1 and 2 (i.e., F1 and F2), which are configured over PLMN1. Similarly, MBS report corresponding to PLMN2 includes information corresponding to frequency 3 (i.e., F3) which is configured over PLMN2. FIG. 4C illustrates a frequency-based MBS report. In the example of FIG. 4C, MBS report corresponding to one or more of frequencies F1, F2, and F3. Furthermore, MBS reports can also be based on one or more MBS service types configured over an MBS frequency.

According to some aspects, an MBS report includes detailed configuration information only when the report is a full-set type report. According to some aspects, the essential-set type MBS report includes an MBS service ID, such as a temporary mobile group ID (TMGI), associated with the MBS transmission. The essential-set type MBS report may also include an identifier corresponding to the PLMN (e.g., a PLMN ID) and/or a cell identifier (e.g., NR cell identity) corresponding to the non-serving cell transmitting the MBS transmissions. The essential-set type MBS report may also include a frequency identifier (e.g., an NR frequency band number or an NR absolute radio frequency channel number (NR-ARFCN)) corresponding to the MBS transmission.

According to some aspects, a full-set type MBS report includes detailed MBS configuration information corresponding to the MBS transmission. The detailed MBS configuration may include information corresponding to MBS bandwidth and location, numerology (e.g., subcarrier spacing), modulation and coding scheme index, discontinuous reception (DRX) parameters, and/or the like. According to some aspects, detailed MBS configuration information may also include information present in an essential-set type report. Accordingly, a full-set type MBS report may include an MBS service ID, PLMN ID, frequency identifier, and/or the like.

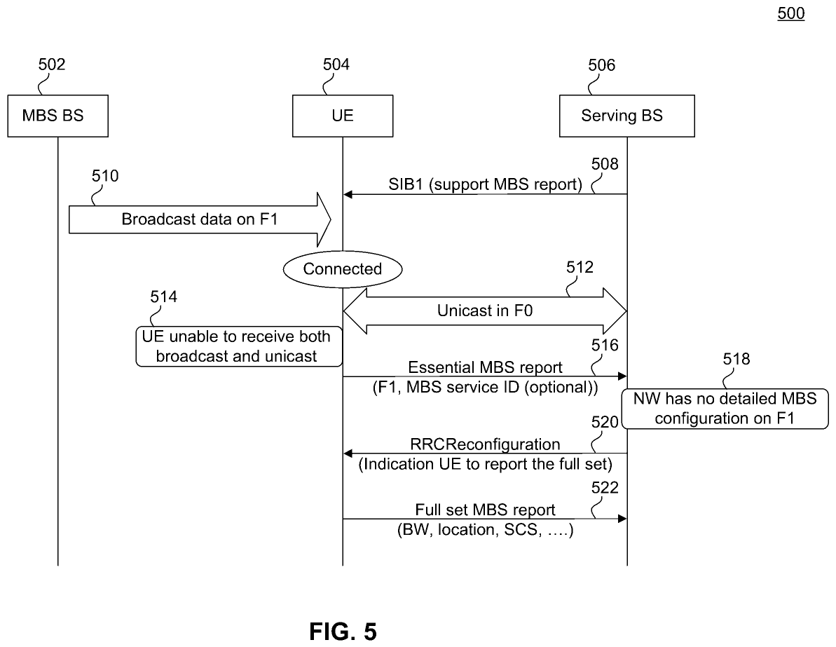

FIG. 5 illustrates an example two-step MBS reporting procedure, according to some aspects of this disclosure. In the example of FIG. 5, UE 504 is in range to communicate with serving BS 506 as well as with a non-serving BS (e.g., MBS BS 502). UE 504 implementing the two-step MBS reporting procedure sends an essential-type MBS report (i.e., an initial MBS report) to the serving BS 506 as a first step of the two-step MBS reporting. Next, based on the extent of MBS configuration information available at the serving BS 506, UE 504 may send the serving BS 506 a full-set type MBS report as the second step of the two-step MBS reporting.

According to some aspects, the two-step MBS reporting procedure begins with the UE 504 receiving SIB1 508 broadcasted by base station 506. In the example of FIG. 5, SIB1 broadcasted by BS 506 can include an indication that BS 506 supports MBS reporting. Subsequently, UE 504 joins a broadcast MBS session of BS 502 and starts receiving a broadcast MBS transmission 510 from MBS BS 502. Next, UE 504 enters an RRC connected state with serving BS 506, and the network configures signal resources to initiate unicast communication 512 between UE 504 and serving BS 506. According to some aspects, UE 504 receives the broadcast MBS transmission 510 from MBS BS 502 over a frequency band F1 and simultaneously receives the unicast transmission 512 from serving BS 506 over frequency band F0.

According to some aspects, UE 504 performs a shared processing of the broadcast MBS transmission 510 received from MBS BS 502 and the unicast transmission 512 received from serving BS 506. Upon simultaneously receiving the broadcast MBS transmission 510 from the MBS BS 502 and the unicast transmission 512 from the serving BS 506, UE 504 can determine whether it has sufficient UE resources to simultaneously process the broadcast MBS transmission 510 and the unicast transmission 512. If the UE 504, at 514, determines that it does not have sufficient UE resources to receive and process the unicast transmission 512 along with the MBS broadcast transmission 510, it can configure an MBS report to send to the serving BS 506. The MBS report serves to inform the serving BS 506 regarding the ongoing MBS broadcast transmission 510 that UE 504 is receiving from MBS BS 502. Alternatively, UE 504 may not have received any MBS transmissions from MBS BS 502, and the MBS report serves to inform the serving BS 506 regarding an MBS broadcast transmission/service that UE 504 is interested in receiving from MBS BS 502.

According to some aspects, UE 504 implementing the two-step reporting scheme first transmits an essential-type MBS report 516 (i.e., an initial MBS report) to the serving BS 506. The essential-type MBS report includes basic information corresponding to the MBS session 510. For example, the essential-type MBS report 516 may include an MBS session ID and/or an identifier corresponding to the MBS frequency band F1. According to some aspects, the essential-type MBS report 516 may include a PLMN ID corresponding to the MBS BS 502. Alternatively or additionally, the essential-type MBS report 516 may indicate a set of frequencies over which the UE 504 may be interested in receiving MBS transmissions.

According to some aspects, serving BS 506 receives the MBS report 516 and determines whether the network has a detailed MBS configuration corresponding to the MBS session ID and one or more frequencies indicated in the MBS report 516. If the network does not have configuration and/or deployment information corresponding to any of the frequencies indicated in the MBS report 516, the serving BS 506 sends an RRC reconfiguration message 520 to UE 504 with an instruction to transmit a full-set type MBS report corresponding to those frequencies. In the example of FIG. 5, at 518 a determination is made that the network does not have a detailed configuration corresponding to the MBS frequency band F1 indicated in the essential-type MBS report 516. Hence, serving BS 506 sends an RRC configuration message 520 to UE 504 indicating an instruction to transmit a full-set type MBS report corresponding to frequency F1.

According to some aspects, after receiving RRC reconfiguration message 520, UE 504 sends a full-set type MBS report 522 corresponding to the frequencies indicated in the RRC reconfiguration message 520. In the example of FIG. 5, UE 504 sends the full-set type MBS report 522 corresponding to frequency F1. According to some aspects, the full-set type MBS report 522 includes one or more of the following information corresponding to MBS frequency F1: bandwidth and location, numerology (e.g., subcarrier spacing), modulation and coding scheme index, discontinuous reception (DRX) parameters, and/or the like. After receiving the full-set MBS report 522, the serving BS 506 can adjust the configuration of signal resources for subsequent unicast transmissions such that UE 504 will be able to receive and process the broadcast MBS transmission 510 and upcoming unicast transmissions, simultaneously.

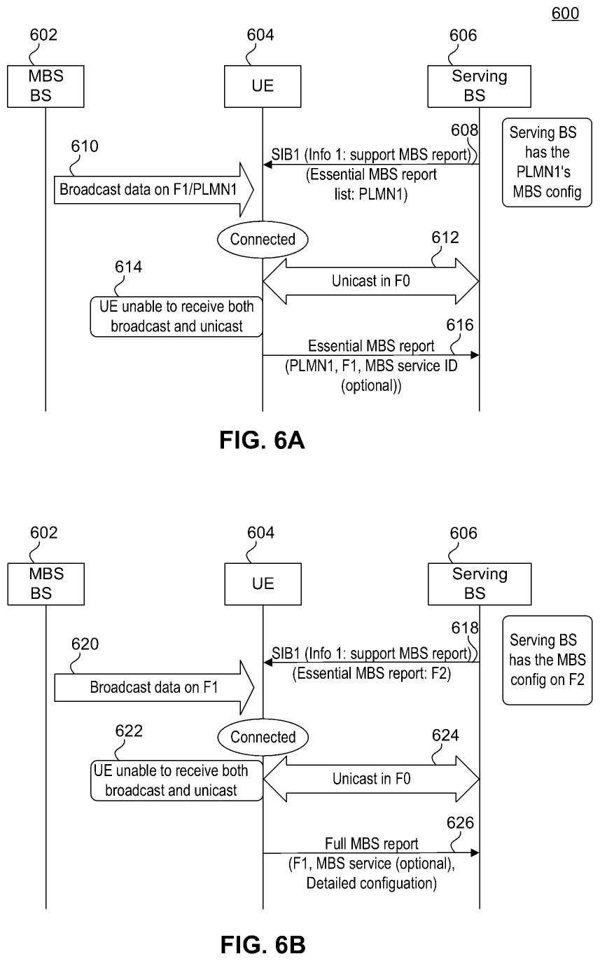

FIGS. 6A-6B illustrate example one-step MBS reporting procedures with broadcast control, according to some aspects of this disclosure. In the examples of FIGS. 6A and 6B, UE 604 is in range to communicate with serving BS 606 as well as with a non-serving BS (e.g., MBS BS 602). According to some aspects, UE 604 implementing the one-step MBS reporting procedure receives a broadcast message from the serving BS 606 indicating a list of PLMNs and/or frequencies for which the network may have MBS configuration and/or deployment information. Based on the list of PLMNs and/or frequencies indicated by the serving BS 606, UE 604 may subsequently send either an essential-type MBS report or a full-set type MBS report to the serving BS 606.

FIG. 6A illustrates an example one-step MBS reporting procedure with broadcast control where serving BS 606 broadcasts a list of PLMNs. According to some aspects, the one-step MBS reporting procedure begins with the UE 604 receiving SIB1 608 broadcasted by BS 606. SIB1 broadcasted by BS 606 includes an indication that BS 606 supports MBS reporting. Furthermore, BS 606 also broadcasts a list of one or more PLMNs for which the network has MBS configuration and/or deployment information. According to some aspects, the list of PLMNs can be included within the SIB1 broadcasted by BS 606.

In the example of FIG. 6A, serving BS 606 has PLMN1's MBS configuration information. Accordingly, the serving BS 606 broadcasts a list that includes PLMN1, as part of SIB 1 608. Subsequently, UE 604 joins a broadcast MBS session of BS 602 and starts receiving broadcast MBS transmissions 610 from MBS BS 602. Next, UE 604 enters an RRC connected state and the network configures signal resources to initiate unicast communication between UE 604 and serving BS 606. According to some aspects, MBS BS 602 belongs to PLMN1. Furthermore, UE 604 receives broadcast MBS transmission from MBS BS 602 over a frequency band F1 and receives a simultaneous unicast transmission from serving BS 606 over frequency band F0. Also, as illustrated in FIG. 4B, frequency F1 configured in PLMN1.

According to some aspects, UE 604 performs a shared processing of the broadcast MBS transmission 610 received from MBS BS 602 and the unicast transmission 612 received from serving BS 606. Upon simultaneously receiving the broadcast MBS transmission 610 from the MBS BS 602 and the unicast transmission 612 from the serving BS 606, UE 604 can determine whether it has sufficient UE resources to simultaneously process the broadcast MBS transmission 610 and the unicast transmission 612. If the UE 604, at 614, determines that it does not have sufficient UE resources to receive and process the unicast transmission 612 along with the MBS broadcast transmission 610, it configures an MBS report to send to the serving BS 606. The MBS report sent to the serving BS 606 can be either an essential-type MBS report or a full-set type MBS report.

According to some aspects, based on the list of PLMNs received from the serving BS 606, UE 604 configures an MBS report and sends it to the serving BS 606. To configure the MBS report, the UE 604 determines whether the PLMN corresponding to the MBS transmission 610 is included in the list of PLMNs received from the serving BS 606. According to some aspects, if UE 604 determines that the PLMN corresponding to the MBS transmission 610 is not included in the list received from the serving BS 606, UE 604 configures an MBS report that includes a full-set type MBS report regarding the PLMN corresponding to the MBS transmission 610. Alternatively, if UE 604 determines that the PLMN corresponding to the MBS transmission 610 is included in the list received from the serving BS 606, UE 604 configures an MBS report 610 that includes only an essential-set type MBS report regarding the PLMN.

In the example of FIG. 6A, the PLMN corresponding to the MBS transmission 610 (i.e., PLMN1) is included in the list received from the serving BS 606. Hence, UE 604 sends an essential-set type MBS report 616 corresponding to PLMN1 and frequency F1. After receiving the essential-set type MBS report, serving BS 606 can adjust the configuration of signal resources for subsequent unicast transmissions such that UE 604 will be able to receive and process the broadcast MBS transmission 610 and upcoming unicast transmissions simultaneously.

FIG. 6B illustrates an example one-step MBS reporting procedure with broadcast control where serving BS 606 broadcasts a list of MBS frequencies. According to some aspects, SIB1 618 broadcasted by BS 606 includes an indication that BS 606 supports MBS reporting. Furthermore, BS 606 also broadcasts a list of one or more frequencies for which the network has MBS configuration and/or deployment information (i.e., a list of MBS frequencies). According to some aspects, the list of MBS frequencies can be included within the SIB1 618 broadcasted by BS 606.

In the example of FIG. 6B, serving BS 606 has MBS configuration information corresponding to a MBS frequency F2. Accordingly, the serving BS 606 broadcasts a list of MBS frequencies that includes frequency F2, as part of SIB1 618. Subsequently, UE 604 joins a broadcast MBS session of BS 602 and starts receiving broadcast MBS transmissions 620 from MBS BS 602. Next, UE 604 enters an RRC connected state and the network configures signal resources to initiate unicast communication between UE 604 and serving BS 606. According to some aspects, UE 604 receives broadcast MBS transmission 620 from MBS BS 602 over a frequency band F1 and receives a simultaneous unicast transmission 624 from serving BS 606 over frequency band F0.

According to some aspects, upon simultaneously receiving the broadcast MBS transmission 620 from the MBS BS 602 and the unicast transmission 624 from the serving BS 606, UE 604 determines whether it has sufficient UE resources (e. g, hardware and/or RF resources) to receive and process the unicast transmission 624 along with the MBS broadcast transmission 620. If UE 604, at 622, determines that it does not have sufficient UE resources to receive and process the unicast transmission 624 along with the MBS broadcast transmission 620, it configures an MBS report to send to the serving BS 606. According to some aspects, based on the list of MBS frequencies received from the serving BS 602, UE 604 configures an MBS report and sends it to the serving BS 606.

To configure the MBS report, UE 604 determines whether the frequency corresponding to the MBS transmission (i.e., frequency F1) is included in the list of MBS frequencies received from the serving BS 606. In the example of FIG. 6B, the frequency corresponding to the MBS transmission (i.e., frequency F1) is not indicated in the MBS frequency list 618 received from the serving BS 606. Hence, UE 604 sends a full-set type MBS report 626 corresponding to frequency F1. Alternatively, if frequency F1 was included in the MBS frequency list 618, UE 604 would send an essential-type MBS report 626 regarding frequency F1.

After receiving the essential-set type MBS report or the full-et type MBS report, serving BS 606 can adjust the configuration of signal resources for subsequent unicast transmissions such that UE 604 will be able to receive and process the broadcast MBS transmission 620 and upcoming unicast transmissions simultaneously.

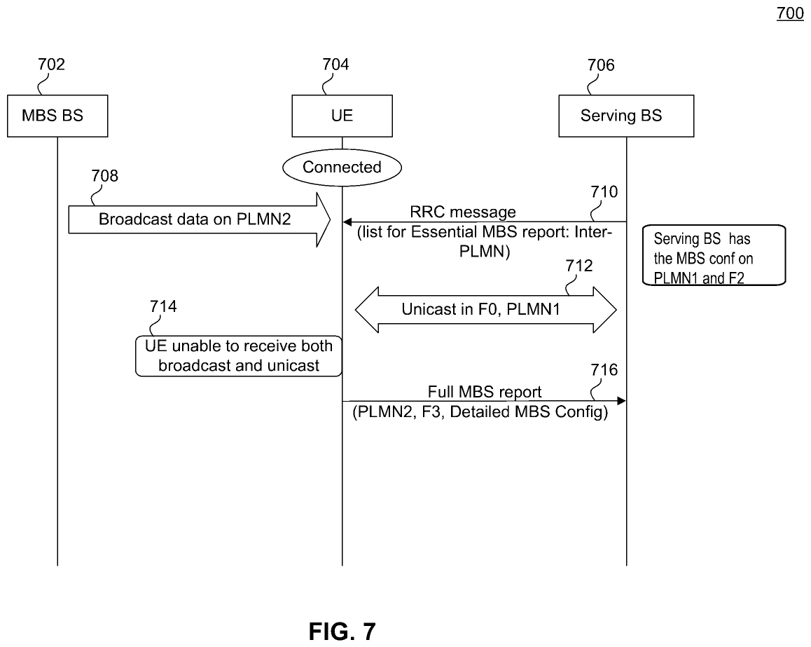

FIG. 7 illustrates an example one-step MBS reporting procedure with dedicated-signaling control, according to some aspects of this disclosure. In the examples of FIG. 7, UE 604 implementing the one-step MBS reporting procedure is in RRC connected state with serving BS 706 and is in rage to communicate with a non-serving BS (e.g., MBS BS 702). According to some aspects, UE 704 implementing the one-step MBS reporting procedure can receive an RRC message (e.g., an RRC reconfiguration message) from the serving BS 706 indicating a list of one or more PLMNs, frequencies, and/or services for which the network may have MBS configuration and/or deployment information. In response to the list received from the serving BS 706, UE 704 may send either an essential-type MBS report or a full-set type MBS report to the serving BS 706.

FIG. 7 illustrates an example one-step MBS reporting procedure with dedicated-signaling control where serving BS 706 sends a list of PLMNs frequencies, and/or services to UE 704 using an RRC message 710 (e.g., an RRC reconfiguration message) to UE 704. The RRC reconfiguration message may include an indication that BS 706 supports MBS reporting. Furthermore, RRC message 710 includes a list of one or more PLMNs, frequencies, and/or services for which the network has MBS configuration and/or deployment information. In the example of FIG. 7, serving BS 706 has MBS configuration information corresponding to PLMN1 and frequency F2.

According to some aspects, UE 704 joins a broadcast MBS session of BS 702 and receives ongoing broadcast MBS transmissions 708 from MBS BS 702. According to some aspects, MBS BS 702 belongs to PLMN2. Furthermore, UE 704 receives broadcast MBS transmission from MBS BS 702 over a frequency band F3 and receives a simultaneous unicast transmission 712 from serving BS 706 over frequency band F0 which is configured in PLMN1.

According to some aspects, UE 704 performs a shared processing of the broadcast MBS transmission received from MBS BS 702 and the unicast transmission received from serving BS 706. Upon simultaneously receiving the broadcast MBS transmission 708 from the MBS BS 702 and the unicast transmission 712 from the serving BS 706, UE 704 can determine whether it has sufficient UE resources (e.g., hardware and/or RF resources) to simultaneously process the broadcast MBS transmission 708 and the unicast transmission 612. If the UE 704, at 714, determines that it does not have sufficient UE resources to receive and process the unicast transmission 712 along with the MBS broadcast transmission 708, it configures an MBS report to send to the serving BS 706. The MBS report sent to the serving BS 606 can be either an essential-type MBS report or a full-set type MBS report. The MBS report serves to inform the serving BS 606 regarding the ongoing MBS broadcast transmission 708. Alternatively, UE 704 may not have received any MBS transmissions from MBS BS 702 yet, and the MBS report serves to inform the serving BS 706 regarding an MBS broadcast transmission/service that UE 704 is interested in receiving from MBS BS 702.

According to some aspects, based on the list of PLMNs, frequencies, and/or services received from the serving BS 706, UE 704 configures an MBS report and sends it the serving BS 706. To configure the MBS report, UE 704 determines whether the PLMN, frequency, and/or service corresponding to the MBS transmission 708 is included in the list received from the serving BS 706. According to some aspects, if UE 704 determines that the PLMN corresponding to the MBS transmission 708 is not included in the list received from the serving BS 706, UE 704 configures an MBS report that includes a full-set type MBS report regarding the PLMN corresponding to the MBS transmission. Alternatively, if UE 704 determines that the PLMN corresponding to the MBS transmission 708 is included in the list received from the serving BS 706, UE 704 configures an MBS report that includes only an essential-set type MBS report regarding the PLMN.

Alternatively, if UE 704 determines that the frequency and/or service corresponding to the MBS transmission 708 is not included in the list received from the serving BS 706, UE 704 configures an MBS report that includes a full-set type MBS report regarding the frequency and/or service corresponding to the MBS transmission 708. Alternatively, if UE 704 determines that the frequency and/or service corresponding to the MBS transmission 708 is included in the list received from the serving BS 706, UE 704 configures an MBS report that includes only an essential-set type MBS report regarding the MBS frequency and/or service.

In the example of FIG. 7, the PLMN and frequency corresponding to the MBS transmission 708 (i.e., PLMN2 and F3) are not included in the list received from the serving BS 706. Hence, UE 704 sends a full-set type MBS report 716 corresponding to PLMN2 and frequency F3. After receiving the full-set type MBS report, serving BS 706 can adjust the configuration of signal resources for subsequent unicast transmissions such that UE 704 will be able to receive and process the broadcast MBS transmission 708 and upcoming unicast transmissions simultaneously.

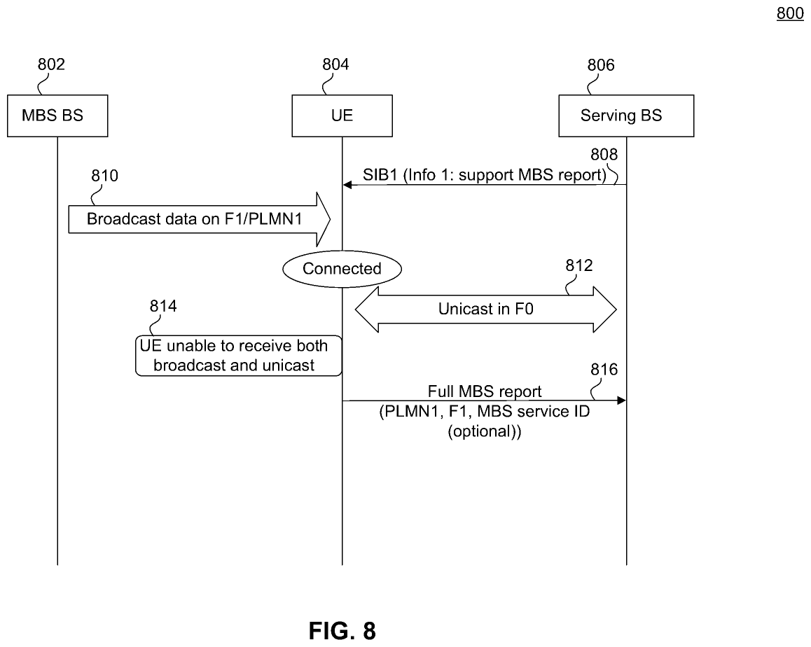

FIG. 8 illustrates an example MBS reporting procedure in which the UE always sends a full-set type report to the serving BS. In the examples of FIG. 8, UE 804 is in range to communicate with BS 806 as well as with BS 802.

According to some aspects, the example MBS reporting procedure begins with the UE 804 receiving SIB1 808 broadcasted by BS 806. SIB1 broadcasted by BS 806 includes an indication that BS 806 supports MBS reporting.

In the example of FIG. 8, UE 804 joins a broadcast MBS session of BS 802 and starts receiving broadcast MBS transmissions 810 from MBS BS 802. Next, UE 804 enters an RRC connected state, and the network configures signal resources to initiate unicast communication between UE 804 and serving BS 806. According to some aspects, MBS BS 802 belongs to PLMN1. Furthermore, UE 804 receives broadcast MBS transmission 810 from MBS BS 802 over a frequency band F1.

According to some aspects, UE 804 performs shared processing of the broadcast MBS transmission 810 received from MBS BS 802 and the unicast transmission 812 received from serving BS 806. Upon simultaneously receiving the broadcast MBS transmission 810 from the MBS BS 602 and the unicast transmission 812 from the serving BS 606, the UE 804 can determine whether it has sufficient UE resources (e.g., hardware and/or RF resources) to simultaneously process the broadcast MBS transmission 810 and the unicast transmission 812. According to some aspects, based on a determination, at 814, that it does not have sufficient resources to receive and process the unicast transmission 812 along with the MBS broadcast transmission 810, UE 804 configures an MBS report to send to the serving BS 806. The MBS report sent to the serving BS 806 is always a full-set type MBS report in the particular example of FIG. 8.

In the example of FIG. 8, UE 604 sends a full-set type MBS report 816 corresponding to MBS PLMN1 and frequency F1. According to some aspects, after receiving the full-set type MBS report, serving BS 806 can adjust the configuration of signal resources for subsequent unicast transmissions such that UE 804 will be able to receive and process the broadcast MBS transmission 610 as well as the upcoming unicast transmissions simultaneously.

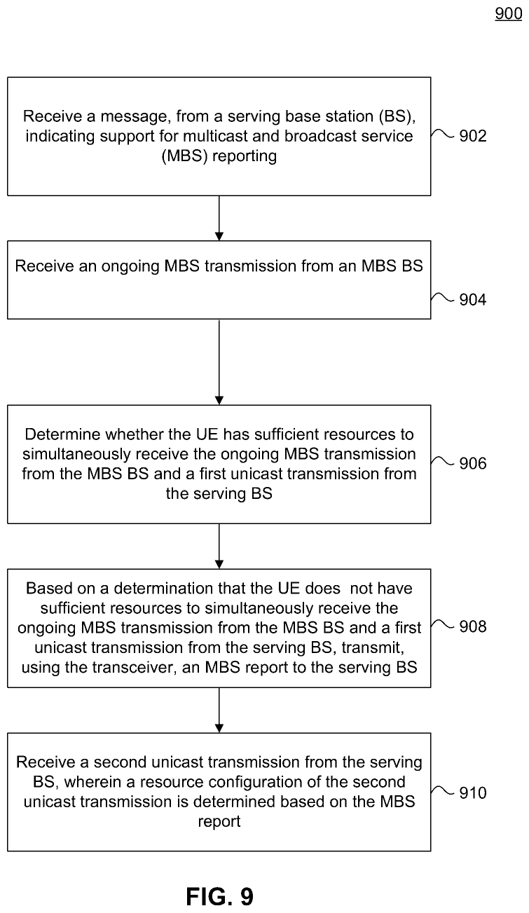

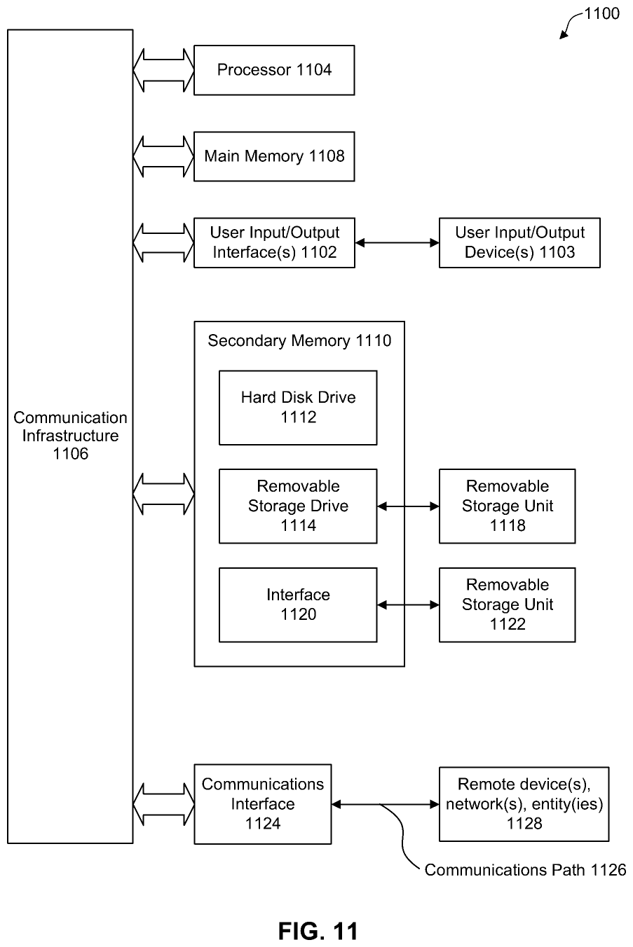

FIG. 9 illustrates an exemplary method 900 performed by a UE implementing MBS reporting for shared processing, according to some aspects of this disclosure. As a convenience and not a limitation, FIG. 9 may be described with regard to elements of FIGS. 1-8 and 11, for example by any one of UEs 102, 308, 402, 504, 604, 704, and 804. Method 900 may also be performed by system 200 of FIG. 2 and/or computer system 1100 of FIG. 11. But method 900 is not limited to the specific aspects depicted in those figures, and other systems may be used to perform the method as will be understood by those skilled in the art. It is to be appreciated that not all operations may be needed, and the operations may not be performed in the same order as shown in FIG. 9.

At 902, UE 102 receives a message, from a serving base station (BS), indicating support for multicast and broadcast service (MBS) reporting. According to some aspects, the message indicating support for MBS reporting is received within a system information block 1 (SIB1) message. Alternatively, the message indicating support for MBS reporting is received within a radio resource control (RRC) reconfiguration message, according to some aspects. According to some aspects, support for MBS reporting corresponds to the serving BS's ability to adjust configuration of signal resources for subsequent transmissions based on an MBS report received from the UE.

At 904, UE 102 receives an ongoing MBS transmission (e.g., MBS broadcast transmission) from an MBS BS. The MBS BS can configure one or more radio bearers to transmit MBS data to the UE 102. According to some aspects, the MBS BS can transmit MBS data to UE 102 over a multicast radio bearer (MRB) that may be shared by multiple other UEs. According to some aspects, the MBS BS can transmit MBS data to UE 102 over a dedicated data radio bearer (DRB). Alternatively, at 904, UE 102 identifies an interested MBS transmission (e.g., an MBS broadcast service UE 102 is interested in receiving) from MBS BS.

At 906, UE 102 determines whether it has sufficient UE resources (e.g., hardware resources and/or RF resources) to simultaneously receive the ongoing MBS transmission from the MBS BS and a first unicast transmission from the serving BS. Alternatively, at 906, UE 102 determines whether it has sufficient UE resources (e.g., hardware resources and/or RF resources) to simultaneously receive the interested MBS transmission and a first unicast transmission from the serving BS.

At 908, based on a determination that the UE 102 does not have sufficient resources to simultaneously receive the ongoing MBS transmission from the MBS BS and the first unicast transmission from the serving BS, UE 102 transmits an MBS report to the serving BS. The MBS report serves to inform the serving BS regarding the ongoing MBS transmission that UE is receiving from MBS BS. Alternatively, the MBS report serves to inform the serving BS regarding the MBS broadcast transmission/service that UE is interested in receiving from MBS BS. According to some aspects, the MBS report sent by UE 102 can be either an essential-type MBS report or a full-set type MBS report.

According to some aspects, the essential-set type MBS report can include an MBS service ID associated with the MBS transmission. The essential-set type MBS report may also include an identifier corresponding to the PLMN (e.g., a PLMN ID) and/or a cell identifier (e.g., NR cell identity) corresponding to the MBS BS transmitting the MBS transmissions. The essential-set type MBS report may also include a frequency identifier (e.g., an NR frequency band number or an NR-ARFCN) corresponding to the MBS transmission. According to some aspects, a full-set type MBS report includes detailed MBS configuration information corresponding to the MBS transmission. The detailed MBS configuration may include information corresponding to MBS bandwidth and location, numerology (e.g., subcarrier spacing), modulation and coding scheme index, discontinuous reception (DRX) parameters, and/or the like. According to some aspects, detailed MBS configuration information may also include information present in an essential-set type report. Accordingly, a full-set type MBS report may include an MBS service ID, PLMN ID, frequency identifier, and/or the like.

According to some aspects, UE 102 may transmit an initial-MBS-report comprising essential-type MBS configuration information regarding the MBS transmission. Next, the UE may receive, from the serving BS, an RRC message indicating a request to transmit full-set type MBS configuration information regarding the frequency corresponding to the MBS transmission. In response to the RRC message, the UE includes, within the MBS report, full-set type MBS configuration information regarding a frequency corresponding to the MBS transmission, and sends the MBS report to the serving base station.

According to some aspects, the message indicating support for MBS reporting may be a list of PLMNs for which the serving BS has MBS configuration information. In such a case, if UE 102 determines that the MBS BS is on a PLMN that is included in the list of PLMNs, it includes essential-set type MBS configuration information corresponding to the PLMN within the MBS report at step 908 and sends it to the serving base station. Alternatively, if UE 102 determines that the MBS BS is not on a PLMN that is included in the list of PLMNs, it includes full-set type MBS configuration information within the MBS report at step 908 and sends it to the serving base station.

According to some aspects, the message indicating support for MBS reporting may include a list of frequencies for which the serving BS has MBS configuration information. In such a case, if UE 102 determines that a frequency corresponding to the MBS transmission is included in the list of frequencies, it includes, within the MBS report, essential-set type MBS configuration information corresponding to the frequency, and sends the MBS report at step 908 to the serving BS. Alternatively, if UE 102 determines that the frequency corresponding to the MBS transmission is not included in the list of frequencies, it sends, to the serving BS, an MBS report at step 908 with full-set type MBS configuration information corresponding to the frequency.

According to some aspects, the message indicating support for MBS reporting may include a list of TMGIs (e.g., each corresponding to one or more MBS services) for which the serving BS has MBS configuration information. In such a case, if UE 102 determines that a TMGI corresponding to the MBS transmission (e.g., an MBS service) is included in the list of TMGIs, it includes, within the MBS report, essential-set type MBS configuration information corresponding to the TMGI corresponding to the MBS transmission, and sends the MBS report at step 908 to the serving BS. Alternatively, if UE 102 determines that the TMGI corresponding to the MBS transmission is not included in the list of TMGIs, it sends, to the serving BS, an MBS report at step 908 with full-set type MBS configuration information corresponding to the TMGI.

At 908, UE 102 receives a second unicast transmission from the serving BS, wherein a resource configuration of the second unicast transmission is determined based on the MBS report. According to some aspects, after receiving the MBS report (i.e., an essential-set type MBS report or a full-set type MBS report), serving BS can adjust the configuration of signal resources for subsequent unicast transmissions such that UE 102 will be able to receive and process the broadcast MBS transmission and upcoming unicast transmissions simultaneously.

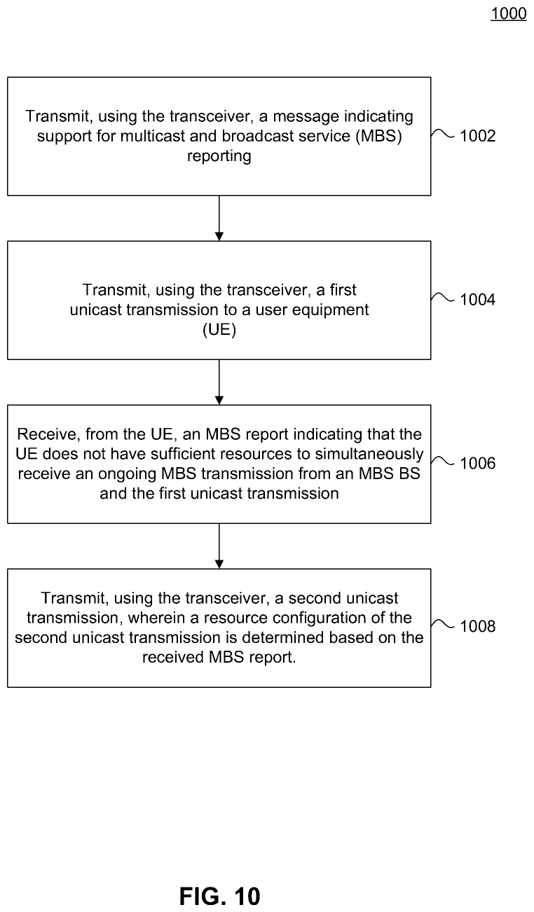

FIG. 10 illustrates an exemplary method 1000 performed by a UE implementing MBS reporting for shared processing, according to some aspects of this disclosure. As a convenience and not a limitation, FIG. 10 may be described with regard to elements of FIGS. 1-8 and 11, for example by any one of serving BSs 106, 404, 506, 606, 706, 806. Method 1000 may also be performed by system 200 of FIG. 2 and/or computer system 1100 of FIG. 11. But method 1000 is not limited to the specific aspects depicted in those figures, and other systems may be used to perform the method as will be understood by those skilled in the art. It is to be appreciated that not all operations may be needed, and the operations may not be performed in the same order as shown in FIG. 10.

At 1002, serving BS 106 transmits a message indicating support for MBS reporting. According to some aspects, the serving BS 106 transmits the message indicating support for MBS reporting within a SIBI message. Alternatively, the message indicating support for MBS reporting is transmitted within a RRC reconfiguration message. According to some aspects, providing support for MBS reporting indicates the serving BS's ability to adjust the configuration of signal resources for subsequent transmissions based on an MBS report received from the UE.

At 1004, the serving BS 106 transmits a first unicast transmission to a UE 102. According to some aspects, UE 102 can have an RRC connection established with the serving BS, and UE 102 can be configured to receive unicast (i.e., non-MBS) transmissions.

At 1006, serving BS 106 receives, from the UE 102, an MBS report indicating that the UE does not have sufficient UE resources to simultaneously receive an MBS transmission from an MBS BS and the first unicast transmission. According to some aspects, the MBS report received by the serving BS can be either an essential-type MBS report or a full-set type MBS report. According to some aspects, the essential-set type MBS report can include an MBS service ID associated with the MBS transmission. The essential-set type MBS report may also include an identifier corresponding to the PLMN (e.g., a PLMN ID) and/or a cell identifier (e.g., NR cell identity) corresponding to the MBS BS transmitting the MBS transmissions. The essential-set type MBS report may also include a frequency identifier (e.g., an NR frequency band number or an NR-ARFCN) corresponding to the MBS transmission.

According to some aspects, a full-set type MBS report includes detailed MBS configuration information corresponding to the MBS transmission. The detailed MBS configuration may include information corresponding to MBS bandwidth and location, numerology (e.g., subcarrier spacing), modulation and coding scheme index, discontinuous reception (DRX) parameters, and/or the like.

At 1008, the serving BS 106 transmits a second unicast transmission, wherein a resource configuration (e.g., number of assigned resource blocks and/or the like) of the second unicast transmission is determined based on the received MBS report. According to some aspects, serving BS According to some aspects, after receiving the MBS report (i.e., an essential-set type MBS report or a full-et type MBS report), serving BS can adjust the configuration of signal resources (e.g., number of assigned resource blocks and/or the like) for subsequent unicast transmissions such that UE 102 will be able to receive and process the broadcast MBS transmission and upcoming unicast transmissions (e.g., the second unicast transmission) simultaneously.

Various aspects can be implemented, for example, using one or more computer systems, such as computer system 1100 shown in FIG. 11. Computer system 1100 can be any well-known computer capable of performing the functions described herein such as UE 102 of FIG. 1. Computer system 1100 includes one or more processors (also called central processing units, or CPUs), such as a processor 1104. Processor 1104 is connected to a communication infrastructure 1106 (e.g., a bus). Computer system 1100 also includes user input/output device(s) 1103, such as monitors, keyboards, pointing devices, etc., that communicate with communication infrastructure 1106 through user input/output interface(s) 1102. Computer system 1100 also includes a main or primary memory 1108, such as random access memory (RAM). Main memory 1108 may include one or more levels of cache. Main memory 1108 has stored therein control logic (e.g., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive.

Removable storage drive 1114 may interact with a removable storage unit 1118. Removable storage unit 1118 includes a computer usable or readable storage device having stored thereon computer software (control logic) and/or data. Removable storage unit 1118 may be a floppy disk, magnetic tape, compact disk, DVD, optical storage disk, and/any other computer data storage device. Removable storage drive 1114 reads from and/or writes to removable storage unit 1118 in a well-known manner.

According to some aspects, secondary memory 1110 may include other means, instrumentalities or other approaches for allowing computer programs and/or other instructions and/or data to be accessed by computer system 1100. Such means, instrumentalities or other approaches may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1100 may further include a communication or network interface 1124. Communication interface 1124 enables computer system 1100 to communicate and interact with any combination of remote devices, remote networks, remote entities, etc. (individually and collectively referenced by reference number 1128). For example, communication interface 1124 may allow computer system 1100 to communicate with remote devices 1128 over communications path 1126, which may be wired and/or wireless, and which may include any combination of LANs, WANs, the Internet, etc. Control logic and/or data may be transmitted to and from computer system 1100 via communication path 1126.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 1100, main memory 1108, secondary memory 1110 and removable storage units 1118 and 1122, as well as tangible articles of manufacture embodying any combination of the foregoing. Such control logic, when executed by one or more data processing devices (such as computer system 1100), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 11. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “aspects” “an example,” “examples,” or similar phrases, indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE), comprising:
a transceiver configured to enable wireless communication; and
a processor, communicatively coupled to the transceiver, and configured to:
receive a message, from a serving base station (BS), indicating support for multicast and broadcast service (MBS) reporting;
based on a determination that the UE does not have sufficient UE resources to simultaneously receive an MBS transmission from an MBS BS and a first unicast transmission from the serving BS, transmit, using the transceiver, an MBS report to the serving BS; and
receive a second unicast transmission from the serving BS, wherein a signal resource configuration of the second unicast transmission is determined based on the MBS report.

2. The UE of claim 1, wherein the message indicating support for MBS reporting is received within a system information block 1 (SIB1) message, and
the processor is further configured to:
transmit, using the transceiver, an initial-MBS-report comprising essential-type MBS configuration information regarding a frequency corresponding to the MBS transmission;
receive, from the serving BS, a radio resource control (RRC) message indicating a request to transmit full-set type MBS configuration information regarding the frequency corresponding to the MBS transmission; and
include, within the MBS report, full-set type MBS configuration information regarding the frequency corresponding to the MBS transmission.

3. The UE of claim 2, wherein the SIB1 message includes an indication of a type of the MBS configuration information that is to be included in the initial-MBS-report, wherein the type of the MBS configuration information is either an essential-type MBS configuration or a full-set type MBS configuration.

4. The UE of claim 1, wherein the message indicating support for MBS reporting includes a list of public land mobile networks (PLMNs) for which the serving BS has MBS configuration information, and
based on a determination that the MBS BS is operating on a PLMN that is included in the list of PLMNs, the processor is further configured to:
include, within the MBS report, essential-set type MBS configuration information corresponding to the PLMN.

5. The UE of claim 4, wherein, based on a determination that the MBS BS is operating on a PLMN that is not included in the list of PLMNs, the processor is further configured to:
include, within the MBS report, full-set type MBS configuration information corresponding to the PLMN.

6. The UE of claim 1, wherein the message indicating support for MBS reporting includes a list of frequencies for which the serving BS has MBS configuration information, and
based on a determination that a frequency corresponding to the MBS transmission is included in the list of frequencies, the processor is further configured to:
include, within the MBS report, essential-set type MBS configuration information corresponding to the frequency.

7. The UE of claim 6, wherein, based on a determination that the frequency corresponding to the MBS transmission is not included in the list of frequencies, the processor is further configured to:
include, within the MBS report, full-set type MBS configuration information corresponding to the frequency.

8. The UE of claim 1, wherein the message indicating support for MBS reporting is received within a SIB1 message.

9. The UE of claim 1, wherein the message indicating support for MBS reporting is received within a RRC message.

10. The UE of claim 1, wherein the MBS report includes essential-set type MBS configuration information regarding a frequency corresponding to the MBS transmission, and wherein the essential-type MBS information comprises one or more of the following: a MBS service identifier and an identifier corresponding to the frequency.

11. The UE of claim 1, wherein the MBS report includes full-set type MBS configuration information regarding a frequency corresponding to the MBS transmission, and wherein the full-set type MBS information comprises one or more of the following: MBS bandwidth, MBS bandwidth location, subcarrier spacing, modulation order, and discontinuous reception (DRX) configuration.

12. A method of operating a user equipment (UE), comprising:
receiving a message, from a serving base station (BS), indicating support for multicast and broadcast service (MBS) reporting;
based on a determination that the UE does not have sufficient UE resources to simultaneously receive an MBS transmission from an MBS BS and a first unicast transmission from the serving BS, transmitting, using the transceiver, an MBS report to the serving BS; and
receiving a second unicast transmission from the serving BS, wherein a signal resource configuration of the second unicast transmission is determined, by the serving BS, based on the MBS report.

13. The method of claim 12, wherein the message indicating support for MBS reporting is received within a system information block 1 (SIB1) message, and further comprising:
transmitting, using the transceiver, an initial-MBS-report comprising essential-type MBS configuration information regarding a frequency corresponding to the MBS transmission;
receiving, from the serving BS, a radio resource control (RRC) message indicating a request to transmit full-set type MBS configuration information regarding the frequency corresponding to the MBS transmission; and
including, within the MBS report, full-set type MBS configuration information regarding the frequency corresponding to the MBS transmission.

14. The method of claim 12, wherein the message indicating support for MBS reporting includes a list of public land mobile networks (PLMNs) for which the serving BS has MBS configuration information, and
based on a determination that the MBS BS is operating on a PLMN that is included in the list of PLMNs, further comprising:
including, within the MBS report, essential-set type MBS configuration information corresponding to the PLMN.

15. The method of claim 12, wherein the message indicating support for MBS reporting includes a list of frequencies for which the serving BS has MBS configuration information, and
based on a determination that a frequency corresponding to the MBS transmission is included in the list of frequencies, further comprising:
including, within the MBS report, essential-set type MBS configuration information corresponding to the frequency.

16. The method of claim 12, wherein the message indicating support for MBS reporting is received within a SIB1 message.

17. The method of claim 12, wherein the MBS report includes full-set type MBS configuration information regarding a frequency corresponding to the MBS transmission, and wherein the full-set type MBS information comprises one or more of the following: MBS bandwidth, MBS bandwidth location, subcarrier spacing, modulation order, and discontinuous reception (DRX) configuration.

18. A base station (BS), comprising:
a transceiver configured to enable wireless communication; and
a processor communicatively coupled to the transceiver and configured to:
transmit, using the transceiver, a message indicating support for multicast and broadcast service (MBS) reporting;
transmit, using the transceiver, a first unicast transmission to a user equipment (UE);
receive, from the UE, an MBS report indicating that the UE does not have sufficient UE resources to simultaneously receive an MBS transmission from an MBS BS and the first unicast transmission; and
transmit, using the transceiver, a second unicast transmission, wherein a signal resource configuration of the second unicast transmission is determined based on the received MBS report.

19. The BS of claim 18, wherein the message indicating support for MBS reporting is transmitted within a system information block 1 (SIB1) message or an RRC message.

20. The UE of claim 1, wherein the MBS transmission is an ongoing MBS transmission or a transmission that the UE is interested in receiving.
